(19) United States
(12) Patent Application Publication
(10) Pub. No.: US 2026/0340395 A1
(43) Pub. Date: Oct. 29, 2026

(54) MULTI-RESOLUTION TEMPORAL MACHINE LEARNING MODEL FOR TEMPORAL KNOWLEDGE GRAPH FORECASTING

(71) Applicant: NEC Laboratories Europe GmbH, Heidelberg (DE)

(72) Inventors: Julia GASTINGER, Heidelberg (DE); Timo SZTYLER, Heidelberg (DE); Federico ERRICA, Heidelberg (DE)

(21) Appl. No.: 19/103,588

(22) PCT Filed: May 8, 2023
(86) PCT No.: PCT/IB2023/054753

§ 371 Date: Feb. 13, 2025

(30) Foreign Application Priority Data
Feb. 15, 2023 (EP) 23156829.6

(51) Int. Cl. G06N 3/0895; G06N 3/042; G06N 3/044; G06N 3/0464

(52) U.S. Cl. CPC G06N 3/0895; G06N 3/042; G06N 3/044; G06N 3/0464

(57) ABSTRACT

A computer-implemented method generates node embeddings for forecasting a temporal knowledge graph from a sequence of temporal knowledge graphs. The sequence includes a plurality of time-steps. The node embeddings are predicted using a machine learning model, which executes a multi-resolution temporal reasoning scheme that, in each update-layer of a graph convolutional network, integrates: an evolvement of nodes and relations in the sequence of temporal knowledge graphs over time; and values of a multi-variate time series of graph-specific parameters extracted from the sequence of temporal knowledge graph.

### CROSS-REFERENCE TO RELATED APPLICATIONS

This application is a U.S. National Phase application under 35 U.S.C. § 371 of International Application No. PCT/IB2023/054753, filed on May 8, 2023, and claims the benefit of EP provisional application 23156829.6, which was filed on Feb. 15, 2023, and which is incorporated herein in its entirety by reference. The International Application was published in English on Aug. 22, 2024 as WO 2024/170945 A1 under PCT Article 21(2).

### FIELD

The present disclosure relates to multi-resolution temporal machine learning model for temporal knowledge graph forecasting.

### BACKGROUND

Prediction of the future, i.e., forecasting, has been an appealing potential of machine learning (ML) solutions, especially in medical and public safety domains. Classic ML-based forecasting methods work surprisingly well when the input is structured as a simple time-series—i.e., the inputs on which the ML forecasting model operates is a time-sequence of values or vectors. However, when the input time-series is of a more complex structure, the state of the art ML-based forecasting methods have proven to be insufficient.

This is particularly true in the field of temporal knowledge graph (TGK) forecasting. A TKG is a time-series of knowledge graphs (KG) of interconnected entities (or nodes). At each point in the time-series, KGs are typically very large and impracticable for humans to inspect, let alone make predictions, which is why there is a need for ML-models to predict how these KGs will change. In particular, there is presently an interest in developing ML-models that are capable of accurately predicting how an interaction between a fixed number of entities will change over time. In the state of the art, this is called “link prediction”.

### SUMMARY

According to an aspect of the present disclosure a computer-implemented method is provided that generates node embeddings for forecasting a temporal knowledge graph from a sequence of temporal knowledge graphs. The sequence includes a plurality of time-steps. The node embeddings are predicted using a machine learning model, which executes a multi-resolution temporal reasoning scheme that, in each update-layer of a graph convolutional network, integrates: an evolvement of nodes and relations in the sequence of temporal knowledge graphs over time; and values of a multi-variate time series of graph-specific parameters extracted from the sequence of temporal knowledge graph.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an embodiment of TKG forecasting ML system;

FIG. 2: illustrates an embodiment of a graph time-series extractor and neighborhood evolution extractor;

FIG. 3 illustrates an embodiment of node embedding predictor;

FIG. 4 illustrates an embodiment of a graph forecaster; and

FIG. 5 is a block diagram of an exemplary processing system, which can be configured to perform any and all operations disclosed herein.

### DETAILED DESCRIPTION

Aspects of the present disclosure provide improvements to temporal knowledge graph (TKG) forecasting ML solutions by introducing a ML model that executes a multi-resolution temporal reasoning scheme, which also incorporates additional knowledge into the learning process—this ML model is referred to herein as a multi-resolution temporal graph network (MR-TGN).

The present inventors have recognized that state of the art ML-based forecasting models have poor forecasting performances, and fail to exploit the structural dependencies between the KG entities. Below are a few examples of the TKG forecast ML models that have been proposed, but have failed to adequately address the problem:
A recurrent evolution network based on graph convolution network (RE-GCN) models the historical KG sequence auto-regressively. After computing node embeddings with a convolutional graph neural network (GGN), RE-GCN applies a recurrent neural network (RNN). This model is not designed for predicting graphs. See Li et. al, “Temporal knowledge graph reasoning based on evolutional representation learning,” in SIGIR '21: The 44th International ACM SIGIR Conference on Research and Development in Information Retrieval, Canada, 2021, pp. 408-417, available at: <<doi.org/10.1145/3404835.3462963>> (hereinafter “Li”) (the entire contents of which is hereby incorporated by reference herein).
A recurrent event network (RE-Net) applies an autoregressive architecture. RE-Net uses two separate steps to learn the temporal dependency from a sequence of graphs and the local structural dependency from the neighborhood. The occurrence of a fact is modeled as a probability distribution conditioned on the temporal sequence of past snapshots. While RE-Net is the only presently-known approach that can predict graphs, RE-Net is not autonomous. For example, RE-Net relies on user input to specify the size of the predicted graph. See Jin et. al, “Recurrent event network: Autoregressive structure inference over temporal knowledge graphs,” in Proceedings of the 2020 Conference on Empirical Methods in Natural Language Processing, 2020, pp. 6669-6683, available at: <<doi.org/10.18653/v1/2020.emnlp-main.541>> (hereinafter “Jin”) (the entire contents of which is hereby incorporated by reference herein).
A complex evolutional network (CEN) uses a convolutional neural network (CNN), which can handle evolutional patterns of different lengths via an “easy-to-difficult” curriculum learning strategy, which learns these evolutional patterns from “short-to-long.” See Li et. al, “Complex evolutional pattern learning for temporal knowledge graph reasoning,” in Proceedings of the 60th Annual Meeting of the Association for Computational Linguistics (Volume 2: Short Papers, Ireland, 2022, pp. 290-296, available at: <<aclanthology.org/2022.acd-short.32>> (hereinafter “Li 2”) (the entire contents of which are hereby incorporated by reference herein)

For the-above mentioned state of the art ML models, the present inventors have identified the following problems:
Problem 1: In the state of the art ML models, temporal reasoning (i.e., the processing of information evolution over time) is logically separated from spatial reasoning (i.e., the processing of graph information at a single time-step). This split only allows for single-resolution temporal reasoning. Because of this technical limitation, the state of the art ML models cannot capture the evolution of the KG entities at different levels of granularity.
Problem 2: The state of the art ML models are algorithmically simplistic in that they are incapable of exploiting additional information, such as seasonality and drift, in the design of the architectures.
Problem 3: The state of the art ML models are not fully automatic. State of the art models rely on human choices, such as for the number of relations or triples, to predict at the next time-step.

MR-TGNs configured according to aspects of the present disclosure solve problems with TKG forecasting that arise due to the structural and temporal properties of a TKG time-series, which have long been unmet by the state of the art. For example, an MR-TGN configured with one or more of the below-listed aspects address at least the above-identified problems of the state of the art:
i. Incorporates a multi-resolution temporal-spatial reasoning mechanism that combines temporal reasoning with spatial reasoning at all different levels of granularity. (Addresses Problem 1);
ii. Integrates time-series statistics in the reasoning process, making use of information such as seasonality of graph-specific parameters. (Addresses Problem 2); and/or
iii. Autonomously determines how many relations/triples to predict for future time-steps (Addresses Problem 3).

Embodiments of the present disclosure, therefore, provide improved ML models (i.e., MR-TGNs) that are designed to perform knowledge graph (KG) forecasting to predict future temporal knowledge graphs (TKG) based on a TKG history. At present, the inventors know of no systems (apart from the MR-TGNs disclosed herein) that can efficiently (from a computational resource standpoint) and timely (from a computer processing time standpoint) process sufficient data (from a type and volume perspective) in such a way to accurately identify patterns and make the predictions accurate enough to enable a practical use of the predictions made.

What immediately follows is a brief overview of how certain terms are used within the meaning of the present disclosure.

A “knowledge graph” (KG) is a machine understandable data structure that provides a semantically-structured representation of information organized as a “graph”. The graph represents entities (e.g., people, places, objects, concepts, etc.) as “nodes”, and relationships between entities (e.g., written by, has color, being married to, being located in, etc.) as “edges” in the graph. Essentially, two nodes connected by a relationship form a “fact” captured by the KG. Each fact is commonly represented in the KG as a “triple”: (subject, relation, object). For example, a KG in the domain of authors and books could represent the fact: F. Scott Fitzgerald wrote the Great Gatsby, as the triple: (The Great Gatsby, written by, F. Scott Fitzgerald). Each node may be associated with additional attributes that further describe the entity or its relationships. For example, the additional fact: “The Great Gatsby was published in 1925” can be represented as the triple: (The Great Gatsby, publication_year, 1925). The KG can also capture missing facts as unknowns in the triple, e.g., (The Great Gatsby, total_sales, ?).

The structure of a KG is characterized by its “parameters.” Parameters of a KG include: number of nodes, number of relations, maximum node degree, maximum degree centrality, and density. A “node degree” refers to a number of edges that are linked to a particular node in the KG. A “maximum node degree” refers to the node degree of a node that has the most edges linked to in as compared to the other nodes in the KG. The “degree centrality” of a node is calculated as the ratio of the number of edges that connect to the node and the total number of nodes in the network. Nodes with higher degree centrality scores are considered more central in the network because they have more connections to other nodes and may have a greater ability to influence information flow or communication in the network. The “maximum degree centrality” refers to the degree centrality of a node that has the highest degree centrality as compared to the other nodes in the KG. “Density” is a measure of how interconnected or dense a knowledge graph is, and it reflects the extent to which the nodes in the graph are connected by edges. Density is usually calculated as the ratio of the actual number of edges in the graph to the total number of possible edges in the graph. The parameters of a KG are distinct from its content, i.e., its particular values for the nodes and edges, as captured by its triples.

A “temporal knowledge graph” (TKG) is a KG coupled with time information. Here, the triples of the KG can be extended to “quadruples” with a fourth element, time, to show that the “facts” captured by the triple are valid (i.e. known to be present) at this time. The quadruple can thus be structured as: (subject, relation, object, time). For example, the fact: “The population of Germany in 1995 was 81.7 million” can be represented as the triple: (Germany, population millions, 81.68, 1995).

A “sequence of TKGs” provides a representation of how the knowledge graph-captured domain changes over a defined time sequence. In the case where the time-sequence is made up of ordered time-steps, each TKG in the sequence is respectively associated with a single time-step. Therefore, the sequence of TKGs can be represented using discrete “KG snapshots.” A KG snapshot is only associated with a single time-step, and contains the triples that are valid at that time-step. For example, a sequence of TKGs representing yearly facts of countries can be represented by a sequence of discrete KG snapshots each associated with a particular year. Continuing the example above, the sequence of TKGs may be represented by discrete KG_{yyyy} snapshots that include: KG₁₉₉₅ and KG₂₀₀₀, where KG₁₉₉₅ includes the triple: (Germany, population millions, 81.68) and KG₂₀₀₀ includes the triple: (Germany, GDP_billions, 1947.8).

By structuring information as KGs and/or as TKGs, a ML model is enabled to understand and operate on the information captured by the KGs or TKGs. The ML model may, for example, take a KG or a TKG as its input and make a prediction based on the information captured therein. In the field of machine learning, “prediction” refers to the process of using a machine-learning model to make statistical estimation of an unknown based on known data. As used herein, “unknown” refers to data that is locally unavailable to the ML model at a time of interest. That is, this data is not necessarily inherently unknown (e.g., unknown to anyone, anywhere at this time) in the global sense—although this case is also included because something that is inherently, presently unknown must also be locally unknown.

“Forecasting” is a subset of machine learning prediction that refers to the machine learning task of estimating an unknown for a point in time that is outside of the input dataset. As used herein, “TKG forecasting” is the machine learning task of predicting a future TKG based on a historical sequence of KG snapshots. While “future” is defined from the perspective of the historical sequence of KG snapshots, it can also include the actual future from the perspective of a user, but ultimately this depends on the task being performed by the ML model.

To make accurate predictions, a ML model should be “trained.” A trained ML model is a computer operable representation of a target system that has been optimized to accurately predict output values for the target system based on new, unseen data. The process of generating a trained ML model involves several steps, including, for example:
Data collection and preprocessing: This involves gathering and cleaning data to ensure that it is accurate, consistent, and ready for use in training the model. This includes tasks such as data labeling, feature engineering, and normalization.
Model selection: This involves selecting an appropriate ML model architecture that is well-suited for the specific task at hand. The ML model can be chosen based on factors such as the type of data, the complexity of the task, and the available computing resources.
Model training: This involves using the training data to train the selected ML model. The model will be repeatedly exposed to the training input data to generate output data, which is compared to expected results from the training data, and then adjustments are made to the models parameters to minimize the error or loss function.
Model evaluation: This involves testing the trained model on a separate dataset to evaluate its performance. This can include metrics such as accuracy, precision, and recall.
Model deployment: This involves deploying the trained model into a production environment where it can be used to make predictions on new data.

The quality of the trained ML model depends on the quality and quantity of the input data, the suitability of the algorithm and model architecture, and the effectiveness of the training process. The quality of a trained ML model can be judge against the accuracy of the predictions, the time needed to make predictions, and the computer resources needed to operate the model.

There are several types of ML model architectures available for use in the art. “Linear models” are one of the simplest classes of ML models, which aim to find a linear relationship between the input features and the output. Examples of linear models include linear regression and logistic regression. “Tree-based models” use decision trees to learn a hierarchy of rules to make predictions. Examples of tree-based models include random forest (RF) and gradient boosting machines (GBMs). “Neural networks” (NN) are a class of models that are loosely based on the structure and function of biological neurons. NN are composed of interconnected layers of nodes that perform nonlinear transformations of the input data. Examples of neural networks include a convolutional neural network (CNN) and a recurrent neural network (RNN).

A Convolutional Neural Network (CNN) is a deep learning architecture that use the concept of convolution to extract features from input data. While CNNs are often used for image processing tasks (e.g., object detection and recognition), the have been increasingly used in natural language processing (NLP) tasks, such as text classification and sentiment analysis. The basic architecture of a CNN includes an embedding layer to convert the input into embeddings, convolutional layers to identify local features in the text, pooling layers to downsample the feature maps, and fully connected layers to make predictions. In the context of CNNs, an “embedding” is a learned representation of discrete input data (e.g., natural language text, attributes, tags) in a continuous vector space.

A “graph convolutional network” (GCN) is a type of neural network that operates on graph-structured data. In contrast to traditional neural networks, GCNs take into account the relationships between nodes in a graph. The basic components of a GCN include graph convolutional layers, which use filters to aggregate information from neighboring nodes in the graph, and pooling layers, which downsample the graph by aggregating information across groups of nodes. The output of the GCN is a set of node embeddings, which can be used for a variety of downstream tasks, such as node classification or link prediction. In the context of GCNs, “node embeddings” are low-dimensional vector representations of the nodes in a graph that capture their structural and semantic properties—i.e., a feature vector that describes the node. The low-dimensional vector space in which the node embeddings are represented is called the “embedding space.” The embedding space is typically learned by the GCN during training. Each dimension of the embedding space represents a different aspect of the node or graph structure, and the distances between embeddings reflect the similarities or dissimilarities between the corresponding nodes. The embedding space can be visualized using techniques such as dimensionality reduction, which can help to identify clusters or patterns in the graph. A GCN, therefore, offers an approach for semi-supervised learning on graph-structured data, such as KGs. On the other-hand, state of the art GCNs do not function well on a sequence of TKGs.

“Message passing” may be used in the GCN to iteratively learn the node embeddings. As described above, in a GCN, each node (e.g. node v) has an associated embedding (e.g. embedding h). Message passing updates the embedding for each node by aggregating a function of embeddings of the neighborhood (e.g., the neighborhood of node v, Nbᵥ) containing neighboring nodes (and potentially relations). This is done in multiple iterations (layers), where each layer (e.g., layer k) takes, as its input, the embedding from the previous layer (e.g., h^{(k-1)}), to compute the embedding of the present layer (e.g., h^{(k)}. With each additional layer, the message passing takes into account more hops in the neighborhood. For example, whereas in the first layer, the node only gets information from its immediate neighbors (1-hop), in the second layer, it gets also information from the neighbors' neighbors (2-hop), and so on.

In GCN, a “neighbor” of a node is any other node that is directly connected to it by an edge in the graph. A “neighborhood” of a node is the set of all its neighbors in the graph, along with the node itself.

A “recurrent neural network” (RNN) is a type of neural network that processes sequential data by incorporating information from previous time-steps. An RNN is made up of a network of interconnected nodes organized in layers. An RNN has feedback connections that allow information to flow in a loop. At each time-step, the RNN takes an input vector and produces an output vector as well as an internal state vector, which is passed to the next time-step. The internal state vector serves as a memory of the network's previous inputs, allowing it to capture temporal dependencies in the data. RNNs may be trained using backpropagation through time (BPTT), which involves computing the gradients of the loss function with respect to the weights at each time-step and then using these gradients to update the weights using an optimization algorithm such as stochastic gradient descent (SGD).

The ML models according to the present disclosure implement a new architecture that goes beyond anything contemplated in the state of the art. According to an aspect of the present disclosure, there is provided an architecture that synergistically combines features of recurrent neural networks (RNNs) and graph convolutional neural networks (RNNs) in a manner which enables the prediction of a KG at a specified point in the future based on a historical sequence of TKGs. The machine learning architecture of the present disclosure also extends the concept of message passing to the temporal domain in a multi-resolutional way.

According to a first aspect of the present disclosure, a method is provided for predicting future knowledge graphs. The method includes one or more of the following steps/components:
0) Record and collect data and organize it in KG snapshots.
1) Extract multi-variate time-series based on the values of graph-specific parameters from a history of KG snapshots (graph time series).
2) Extract the neighborhood for each node for each KG snapshot in a history of KG snapshots.
3) Predict future node embeddings, using a multi-resolution temporal reasoning scheme that integrates the evolvement (change) of the entities over time as well as the value of the multi-variate graph time-series in each update-layer of the Graph Network.
   a. In addition, in each update step of the graph convolutional network, seasonality information may be integrated to train a recurrent model.
   b. Predict scores for each node/triple in future time-step(s) using a scoring function. The scores computed with the scoring function represent how likely triples are from all potential triples.
4) Predict a set of triples (KG snapshot) for each future time-step of interest, by:
   a. Forecasting graph specific parameters from the graph time-series using a multi-variate time-series forecasting model.
   b. Sampling based on the predicted parameters and based on the scores from 3.b the triples with the highest expected scores. The number of triples that are predicted depends on the forecast graph specific parameters. Sampling refers to the process of selecting a subset of items (in this context: triples) from a larger population or dataset (in this context: the set of all possible triples, i.e. all possible combinations of (subject, relation, object)). The subset of items selected is called a sample.

According to a second aspect of the present disclosure, a method is provided for predicting future knowledge graphs. The method includes one or more of the following steps/components:
1) Using a reasoning scheme that integrates the temporal evolution of the entities and relations in a knowledge graph over time in each update-layer of a graph convolutional network;
2) Incorporating information about the temporal evolution of the graph in the graph convolutional network to compute the node embeddings, which may include:
   a. extracting a multi-variate time-series that describes the graph at each time-step based on graph parameters;
   b. integrating this time-series in each update of the graph convolutional network; and/or
   c. extracting the seasonality from that multi-variate time-series and training a separate model instantiation for each step in the period; and/or
3) Predicting the future knowledge graphs based on the forecast graph-specific parameters, which may include:
   a. extracting a multi-variate time-series that describes the graph at each time-step based on graph parameters;
   b. forecasting the future values of that multi-variate time-series; and/or
   c. sampling the number of nodes and triples based on predicted embeddings and based on the forecast values of the time-series.

According to a third aspect, a computer-implemented method is provided for generating node embeddings for generating a forecasted temporal knowledge graph from a sequence of temporal knowledge graphs, the sequence including a plurality of time-steps. The method includes: predicting the node embeddings, using a machine learning model, which executes a multi-resolution temporal reasoning scheme that, in each update-layer of a graph convolutional network, integrates: an evolvement of nodes and relations in the sequence of temporal knowledge graphs over time; and values of a multi-variate time series of graph-specific parameters extracted from the sequence of temporal knowledge graphs. The method of the third aspect may further include predicting the forecasted temporal knowledge graph based on the predicted node embeddings. Below, several exemplary implementations of the method according to the third aspect of the present disclosure are described. As a person of ordinary skill in the art would recognize, these implementations of the third aspect may be variously combined with one or more of the other exemplary implementations.

According to a first implementation of the third aspect, predicting the node embeddings, using the machine learning model, includes: computing scores, based on the predicted node embeddings, for a plurality of triples corresponding to a future time-step. Further, the method further includes predicting the forecasted temporal knowledge graph based on the predicted node embeddings by: forecasting graph-specific parameters based on the values of the multi-variate time series of graph-specific parameters; and predicting a set of forecasted triples as the forecasted temporal knowledge graph based on the computed scores and the forecasted graph-specific parameters.

According to a second implementation of the third aspect, the predicting the node embeddings, using the machine learning model, further includes: integrating, in each update-layer of the graph convolutional network, seasonality information; and training a recurrent model component of the machine learning model using the seasonality information.

According to a third implementation of the third aspect, the method further includes: extracting, based on the sequence of the temporal knowledge graphs, the multi-variate time series of graph-specific parameters, each entry including a time-series of values of one of the graph-specific parameters characterizing the temporal knowledge graphs at the time-steps; and extracting, based on the sequence of the temporal knowledge graphs, a neighborhood evolution identifying neighbors of each node in the temporal knowledge graphs at the respective time-steps. The evolvement of the nodes may include the extracted neighborhood evolution.

According to a fourth implementation of the third aspect, the sequence of temporal knowledge graphs includes a plurality of knowledge graph snapshots, each knowledge graph snapshot corresponding to a respective time-step of the time-steps in the sequence, and extracting the multi-variate time series of graph-specific parameters includes, iteratively, for each of the time-steps: extracting a respective value for each parameter of the graph-specific parameters of the knowledge graph snapshot corresponding to the respective time-step; and adding the respective value for each parameter of the graph-specific parameters to the time-series of values of the respective one of the graph-specific parameters.

According to a fifth implementation of the third aspect, the sequence of temporal knowledge graphs includes a plurality of knowledge graph snapshots, each knowledge graph snapshot being correlated with a respective time-step of the time-steps in the sequence, and generating the neighborhood time sequence comprises, iteratively, for each of the time-steps: for each node of the knowledge graph snapshot corresponding to the respective time-step: identifying all of the neighbors of the respective node; and adding to a respective node entry in the neighborhood time sequence, the identified neighbors of the respective node.

According to a sixth implementation of the third aspect, the machine learning model includes a multi-resolution temporal graph network (MR-TGN) model, which includes: a graph convolutional neural network model component; and a recurrent neural network model component. The MR-TGN model is configured to execute a message passing operation to update embeddings at each node of the graph convolutional network, the message passing operation comprising passing both the evolvement of nodes and the values of the multi-variate time series of graph-specific parameters according to a respective one of the time steps corresponding to the node.

According to a seventh implementation of the third aspect, the predicting the node embeddings, using the machine learning model, further includes: computing node embeddings

$${h}_{v , t}^{( k )}$$

of the graph convolutional network using equations:

$${z}_{v , t}^{( k )} = {f}_{s} ( {h}_{v , t - 1}^{( k )} )$$

$${r}_{v , t}^{( k )} = {g}_{s} ( {h}_{v , t - 1}^{( k )} )$$

$${\tilde{h}}_{v , t}^{( k )} = {MLP}^{( k )} ( [ \begin{matrix}0 \\ 0 \\ {G}_{t}\end{matrix} ] + [ \begin{matrix}{h}_{v , t - 1}^{( k )} \\ 0 \\ 0\end{matrix} ] ⊙ [ \begin{matrix}{r}_{v , t}^{( k )} \\ 0 \\ 0\end{matrix} ] + ( 1 + {ε}^{( k )} ) [ \begin{matrix}{h}_{v , t}^{( k - 1 )} \\ 0 \\ 0\end{matrix} ] + {\sum }_{u ∈ N {b}_{v , t}} [ \begin{matrix}{h}_{u , t}^{( k - 1 )} \\ {h}_{u v} \\ 0\end{matrix} ] )$$

$${h}_{v , t}^{( k )} = ( 1 - {z}_{v , t}^{( k )} ) ⊙ {\tilde{h}}_{v , t}^{( k )} + {z}_{v , t}^{( k )} ⊙ {h}_{v , t - 1}^{( k )} ,$$

Here fₛ( ) and gₛ( ) are single-layer, multi-layer perceptrons (MLPs), s indicating that a different MLP model is used for each seasonality, k is the update-layer, and t is the time-step, v is a node identification within an embedding space of the graph convolutional network,

$${h}_{v , t}^{( k )}$$

is an embedding of the node v at the respective time-step t, and the respective layer k, hᵤᵥ is an embedding of a relation that connects u and v at a present time-step, Nb_{v,t} is a neighborhood of the node v at the time-step t from the evolvement of nodes, operator ⊙ is the Hadamard product, ϵ is a learnable parameter of the model, Gₜ is a vector entry at the time-step t in the multi-variate time series of graph-specific parameters, and on the notation, 0 And 1 are all-zeros and all-ones vectors of the embedding dimension or dimension of Gₜ.

According to an eighth implementation of the third aspect, the predicting of the forecasted temporal knowledge graph based on the predicted node embeddings includes: executing a scoring function based on the predicted node embeddings corresponding to a last layer of the graph convolutional network and a time of interest to predict a plurality of future nodes; and predicting a set of triples based on the predicted plurality of future nodes. The forecasted temporal knowledge graph includes the predicted set of triples for the time of interest.

According to a ninth implementation of the third aspect, the predicting of the forecasted temporal knowledge graph based on the predicted node embeddings includes: predicting graph-specific parameter values for a future time of interest based on the a multi-variate time series of graph-specific parameters using a multi-variate time-series forecasting model; and constraining the predicted plurality of future nodes based on the predicted graph-specific parameter values.

According to a tenth implementation of the third aspect, the predicted graph-specific parameter values comprises at least one of a number of nodes in the future time of interest and/or a number of triples at a future time-step.

According to an eleventh aspect of the third aspect, the graph-specific parameters comprise at least one of: a number of nodes, a number of relations, a maximum node degree, a maximum degree centrality, or a density.

According to a fourth aspect, a computer-implemented method is provided for generating a forecasted temporal knowledge. The method includes predicting the temporal knowledge graph based on received predicted node embeddings, the node embeddings having been received from a machine learning model configured to predict node embeddings from a sequence of temporal knowledge graphs.

According to a first implementation of the fourth aspect, predicting the forecasted temporal knowledge graph based on the predicted node embeddings by includes: forecasting graph-specific parameters based on values of a multi-variate time series of graph-specific parameters; and predicting a set of forecasted triples as the forecasted temporal knowledge graph based on computed scores and the forecasted graph-specific parameters. The values of a multi-variate time series of graph-specific parameters having been extracted from the sequence of temporal knowledge graphs. The score having been computed based on predicted node embeddings for a plurality of triples corresponding to a future time-step.

According to a fifth aspect, a system including at least one processor is provided. The at least one processor is configured to perform the method according to any implementation of the first through fourth aspects of the present disclosure.

According to a fifth aspect, a non-transitory computer readable storage medium is provided, that includes instructions, which when executed cause the performance of the method according to any implementation of the first through fourth aspects of the present disclosure to be executed.

According to a sixth aspect, a temporal knowledge graph (TKG) forecasting machine learning system is provided. The TKG forecasting machine learning system comprises: a TKG pre-processing front end; and a multi-resolution temporal graph network (MR-TGN). The TKG pre-processing front end is configured to generate (extract), based on a sequence of KG snapshots, a multi-variate time series of graph-specific parameters of each graph in a collection of KG snapshots and a neighborhood evolution, which represents a dictionary of neighbors of each node in the TKGs at the respective time-steps. The MR-TGN is configured to compute node embeddings for each node, and for each time-step of the KG snapshots, score the computed node embeddings h in order to predict triples for a future time-step; and to generate at least one predicted TKG for the future time step.

Compared the state of the art ML models, embodiments of the present disclosure have at least the following advantages:
1. Embodiments of the present disclosure implement ML models that are configured to take into account the temporal reasoning at multiple resolutions, that is, layers of the deep network, which increases the types of transformations that the models can learn. These design choices lead to, for example, improved forecasting capabilities (e.g., higher forecasting accuracy) compared to state of the art models.
2. Embodiments of the present disclosure implement ML models that are configured to use of additional information about the temporal evolution of the graph, enabling the models to learn to process different temporal patterns, such as seasonality, in potentially completely different ways.
3. Embodiments of the present disclosure implement ML models that solve the problem of choosing the properties of the graph to predict, e.g., the number of triples, at the next time-steps, thus facilitating the job of the user who had to take such decisions based on expertise. This leads to a more realistic generation of the graph structures.

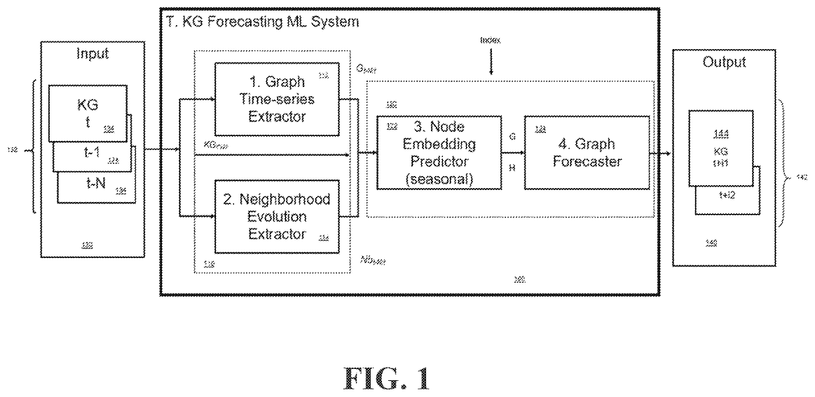

FIG. 1 illustrates a TKG forecasting ML system 100 and its method of operation according to an embodiment of the present disclosure.

The TKG forecasting ML system 100 includes in its architecture: a TKG pre-processing front end 110; and a multi-resolution temporal graph network (MR-TGN) 120.

The input 130 to the a TKG forecasting ML system 100 is a sequence of temporal knowledge graphs (TKGs) 132, represented as a collection of KG snapshots 134, where one KG snapshot 134 contains all triples for one time-step (e.g., t-N). The duration of the sequence and/or the period of each time-step may be pre-specified (e.g., pre-specified by a user, or inherently defined by the input 130). Prior to operation of the TKG forecasting ML system 100, the input 130 may have been generated based on a collection of data associated with a target domain.

The TKG pre-processing front end 110 receives and processes the sequence of TKGs 132 to provide data structured for efficient operation by the MR-TGN 120. To this end, the TKG pre-processing front end 110 includes a graph time series extractor (GTE) 112; and a neighborhood evolution extractor (NEE) 114. Both the graph time series extractor (GTE) 112 and the neighborhood evolution extractor (NEE) 114 receive, as their input, the sequence of TKGs 132 as the collection of discrete KG snapshots 134.

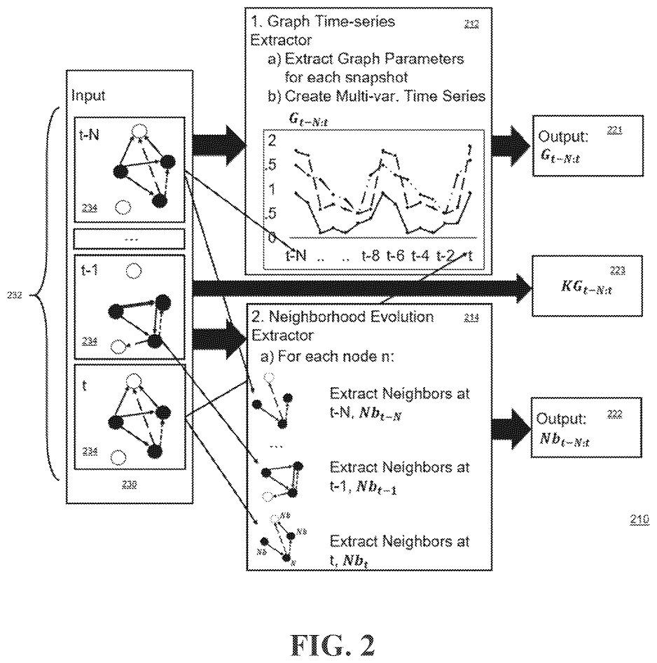

The graph time-series extractor (GTE) 112 outputs, based on the collection of KG snapshots 134, a multi-variate time series G_{t-N:t} of the graph-specific parameters of each graph in the collection of KG snapshots 134. Further details of an embodiment of the graph time-series extractor (GTE) 112 are given below in connection with FIG. 2.

The neighborhood evolution extractor (NEE) 114 outputs, based on the collection of KG snapshots 134, a neighborhood evolution Nb_{t-N:t}, which represents a dictionary of neighbors of each node in the temporal knowledge graphs at the respective time-steps. Further details of an embodiment of the neighborhood evolution extractor (NEE) 114 are given below in connection with FIG. 2.

The MR-TGN 120 receives the raw and pre-processed KG snapshot data and generates a TKG forecast as its output 140. The MR-TGN includes a ML model that is configured to generate node embeddings by executing a multi-resolution temporal reasoning scheme, which integrates the evolvement of the entities (e.g., the nodes in the TKGs) over time and the values of a multi-variate time series of the graph-specific parameters in each update layer of a graph convolutional network. To this end, the MR-TGN's ML model has an architecture that combines concepts taken from both recurrent neural network (RNN) models and graph convolutional neural network (GCN) models, which are further configured to account for time dependent information for example by extending the concept of message passing to the temporal domain in a multi-resolutional way. In the present embodiment, the MR-TGN 120 includes a node embedding predictor 122 and a graph forecaster 124. The graph convolutional network may correspond to a two-dimensional embedding space corresponding to the update-layers and time-steps.

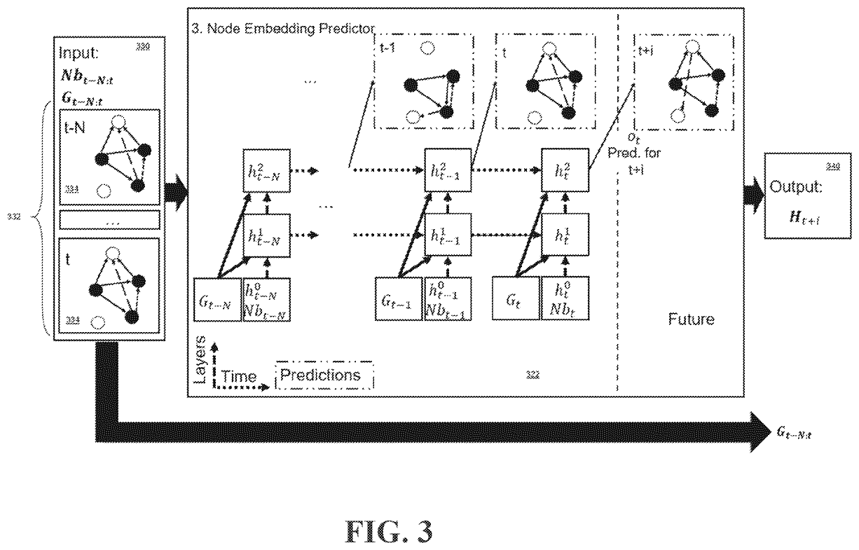

As shown in the present embodiment, the MR-TGN 120 receives: the multi-variate time series G_{t-N:t}; the neighborhood evolution Nb_{t-N:t}; and the KG snapshots KG_{t-N:t} as inputs to its node embedding predictor 122. The node embedding predictor 122 outputs a predicted set of node embeddings Hₜ₊ⱼ for at least one future time-step of interest. The node embedding predictor 122 may receive an index indicating at least one future time-step of interest as an additional input, or may be previously configured with the index (e.g., by a user). Further details of an embodiment of the node embedding predictor are given below in connection with FIG. 3.

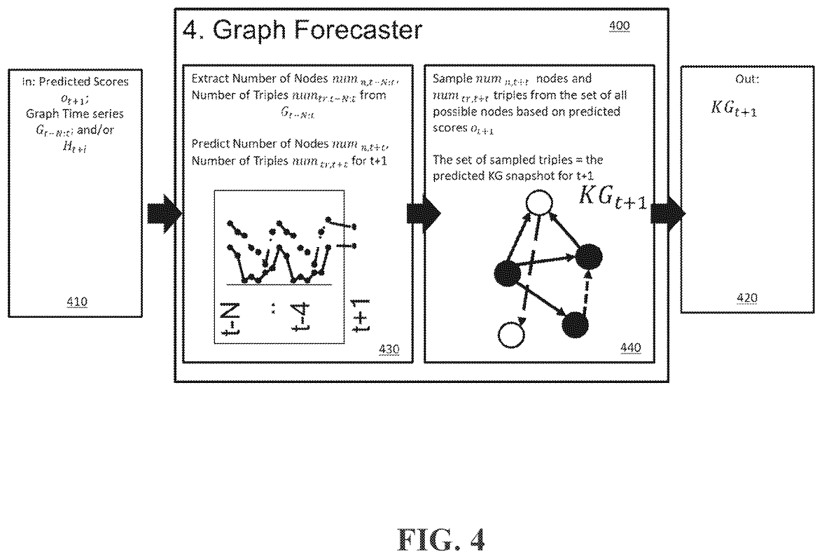

The graph forecaster 124 receives as inputs the predicted set of node embeddings Hₜ₊ⱼ for at least one future time-step of interest and the multi-variate time series G_{t-N:t} of the graph-specific parameters. The graph forecaster 124 is configured to provide the a prediction of at least one KG at the indicated future time-step as the output 140 of the TKG forecasting ML system 100. The prediction may be output as a plurality of predicted triples at the indicated future time-steps. Further details of an embodiment of graph forecaster are given below in connection with FIG. 4.

The output 140, therefore, may provide a predicted KG snapshot 144 at a specific future time-step (e.g., t+i1, t+i2, . . . etc.) or a predicted sequence of TKGs 142 at a plurality of future time-steps.

FIG. 2 illustrates an embodiment of a TKG pre-processing front end 210 of TKG forecasting ML system (such as may be implemented as the TKG pre-processing front end 110 in the TKG forecasting ML system 100) and its method of operation.

The TKG pre-processing front end 210 includes a graph time-series extractor (GTE) 212 that receives as a collection of KG snapshots KG_{t-N:t} from the input 232.

The collection of KG snapshots KG_{t-N:t} corresponds to a sequence of TKGs 232. The sequence of TKGs may be provided externally from the TKG forecasting ML system (e.g., by a user). The sequence of TKGs 232 may generated from a data source of a domain of interest that includes temporal data indicating how the domain of interest has been observed to change over defined time sequence. Each TKG in the sequence of TKGs 232 is represented by an individual KG snapshot 234 correlated to a particular time-step (e.g., t-N) in the sequence. The discrete KG snapshots 234, therefore, combine to form the collection of KG snapshots KG_{t-N:t}.

Each KG snapshot 234 in the collection of KG snapshots KG_{t-N:t} contains a KG characterized by its content and parameters. The content of the KG corresponds to the collection of “facts” for the target domain as they were determined at the time-step captured in the particular snapshot. These “facts” of the KG are semantically-structured as a graph of nodes and edges, which are expressed by a set of triples (subject, relation, object). The parameters of each KG (i.e., graph-specific parameters) define its structure (e.g., how the nodes and edges are arranged in the graph-space). The parameters of the KG may include: the number of nodes, the number of relations, the maximum node degree, the maximum degree centrality, the density, and the like.

The graph time-series extractor (GTE) 212 extracts a time-series from the collection of KG snapshots KG_{t-N:t} based on the parameters of each KG contained therein.

The extracted time-series describes how the structure of the KGs captured in the KG snapshots KG_{t-N:t} evolve over time. For example, the extracted time-series may describe how the number of nodes present in each KG changes over the time-series captured in the snapshots. Embodiments implemented according to the present disclosure are not limited thereto, however, and may extract one, several, or all of the graph-specific parameters for each time-step, including, the number of nodes, the number of relations, the maximum node degree, the maximum degree centrality, and the density of the KGs associated with each time-step.

In the example shown, for each KG snapshot 234 in the given collection of KG snapshots KG_{t-N:t}, for the given historic time-steps t−N:t, the graph time-series extractor (GTE) 212 determines the values of a plurality of graph-specific parameters. The graph time-series extractor (GTE) 212 then creates a time-series for each of the graph-specific parameters, indicating the value of the respective parameter at every time-step. The output 221 of graph time-series extractor (GTE) 212 is provided as a multi-variate time-series of the graph-specific parameters G_{t-N:t}, where each entry contains the time-series for one of the graph-specific parameters.

Table 1 illustrates exemplary pseudo-code for a graph time-series extractor that is configured to extract a multi-variate time-series of graph-specific parameters from a sequence of temporal knowledge graphs (TKGs). In the example, as with the above embodiment, the sequence of TKGs are represented by a collection of KG snapshots. Also, each entry in the time-series contains the time-series of one of the parameters. In the example, the parameters are pre-defined, however, other embodiments may automatically discover the parameters based on, e.g., meta-data associated with the KG snapshots:

TABLE 1
Graph Time-Series Extractor

```
function extract_time_series(temporal graphs):
  // Initialize an empty dictionary to hold the time-series
  time_series = { }
  // For each time-step in the sequence of temporal graphs, extract the corresponding
  knowledge graph snapshot
  for time_step in temporal_graphs.get_time_steps( ):
    knowledge_graph = temporal_graphs.get_knowledge_graph(time_step)
    // Extract the parameters of the knowledge graph
    num nodes = knowledge_graph.get_num_nodes( )
    num relations = knowledge_graph.get_num_relations( )
    max_node_degree = knowledge_graph.get_max_node_degree( )
    max_degree_centrality = knowledge_graph.get_max_degree_centrality( )
    density = knowledge_graph.get_density( )
    // Add the parameters to the time-series dictionary
    if 'num_nodes' not in time_series:
      time_series['num_nodes'] = [ ]
    time_series['num_nodes'].append(num_nodes)
    if 'num_relations' not in time_series:
      time_series['num_relations'] = [ ]
    time_series['num_relations'].append(num_relations)
    if 'max_node_degree' not in time_series:
      time_series['max_node_degree'] = [ ]
    time_series['max_node_degree']. append(max_node_degree)
    if 'max_degree_centrality' not in time_series:
      time_series['max_degree_centrality'] = [ ]
    time_series['max_degree_centrality'].append(max_degree_centrality)
    if 'density' not in time_series:
      time_series['density'] = [ ]
    time_series['density'].append(density)
// Return the resulting multi-variate time-series
return time_series
```

As indicated in the pseudo-code, the algorithm executed by the graph time-series extractor iterates over each time-step in sequence, and for each time-step, extracts the desired parameters from the corresponding knowledge graph snapshot. The algorithm then adds the parameters to the time-series dictionary, initializing a new time-series list if necessary. The resulting dictionary of time-series is returned. As a person of ordinary skill would recognize, this pseudo-code is exemplary and corresponds to an exemplary algorithm for a graph time-series extractor. Extractors may also be implemented that extract the time series for other parameters (properties) from a sequence of temporal knowledge graphs (TKGs) by, for example, modifying the pseudo-code for those parameters.

FIG. 2 also illustrates an embodiment of a neighborhood evolution extractor (NEE) 214 (which may be implemented, e.g., as the NEE 114 in the TKG forecasting ML system 100) and its method of operation.

The neighborhood evolution extractor (NEE) 214 extracts the neighborhood for each node n for each KG snapshot 234 in the collection of KG snapshots KG_{t-N:t}, for time-steps t−N:t.

The output 222 of neighborhood evolution extractor (NEE) 214 is a neighborhood evolution dataset Nb_{t-N:t}. The neighborhood evolution dataset Nb_{t-N:t} provides a dictionary of the neighbors nb for each node n as respectively captured in each of the collection of KG snapshots KG_{t-N:t}, according to the individual time-step. That is, the neighborhood evolution dataset Nb_{t-N:t}. extracted from the collection of KG snapshots KG_{t-N:t} includes a neighborhood dictionary listing neighbors of each node at each time-step t−N:t. that is Nb_{t-N:t}{Nb_{t-N}, . . . , Nbₜ}.

Table 2 illustrates exemplary pseudo-code for neighborhood evolution extractor (NEE) that is configured to extract the neighborhoods for each knowledge graph in a time sequence and return, for each of the time-steps in the sequence, a dictionary of neighborhoods identifying the neighbors for each node.

TABLE 2
Neighborhood Evolution Extractor:

```
function extract_neighborhood_evolution(temporal_graphs):
// Initialize an empty dictionary to hold the neighborhood for each node in each
timestep
neighborhood = { }
// For each time-step in the sequence of temporal graphs, extract the corresponding
knowledge graph snapshot
for time_step in temporal_graphs.get_time_steps( ):
  neighborhood[t] = { }
  knowledge graph = temporal_graphs.get_knowledge_graph(time_step)
  // For each node in knowledge graph: extract the neighbors (up to n_max hops,
  where n_max depends on the layers chosen for the Node Embedding predictor
  (hyperparameter))
  for node in knowledge_graph.get_nodes( ):
    neighbors = [ ]
    // For each node: extract the neighbor node, in the first, second, .. up to
    n_max hop neighborhood and store it in a list. The list has one entry (list)
    per hop.
    for hop in range(1, n_max):
      neighbor_list = knowledge_graph.find_neighbors(node, hop)
      neighbors.append(neighbor_list)
    // add the list to the neighborhood dictionary
    neighborhood[t][node] = neighbors
// Return the neighborhood
return neighborhood
```

FIG. 3 illustrates an embodiment of a node embedding predictor 322 (which may be implemented, e.g., as the node embedding predictor 122 of the MR-TGN 120 in the TKG forecasting ML system 100) and its method of operation.

The node embedding predictor 322 is a ML model having an architecture that combines concepts taken from both recurrent neural network (RNN) models and graph convolutional neural network (GCN) models, while also being configured to account for time dependent information. The node embedding predictor 322 advantageously extends the ML concept of message passing to the temporal domain in a multi-resolutional way.

The node embedding predictor 322 receives as inputs 330:
(1) a sequence of TKGs 322, which is represented by a collection of KG snapshots 334, each being for a time-step in the sequence;
(2) a multi-variate time-series of graph-specific parameters G_{t-N:t} (e.g., from GTE 212), which characterizes the sequence of TKGs 322; and
(3) a neighborhood evolution dataset Nb_{t-N:t} containing the neighborhoods Nb_{t-N}, . . . , Nbₜ from each time-step (e.g., as generated (extracted) by NEE 214).

The node embedding predictor 322 is able to compute (i.e., learn) node embeddings

$${h}_{n , t}^{( k )}$$

for each node, and for each time-step (with superscript k indicating the layer (i.e., update-layer), subscripts n indicating the node, and t indicating the time-step). The node embedding predictor 322 is also able to score the computed node embeddings

$${h}_{n , t}^{( k )}$$

in in order to predict triples for future time-steps t+i. Finally, the node embedding predictor 322 is able to accurately predict the node embeddings for at least one future time-step (t+i1, t+i2, . . . ).

The output 340 of the node embedding predictor 322 is a set of node embeddings

$${H}_{t + i} = \{ {h}_{N , t + i}^{( K )} , … , {h}_{N , t + i}^{( K )} \} ,$$

with N being the number nodes for each future time-step of interest, (e.g., one or more of: t+i′ . . . , t+i), and K indicating the highest layer (e.g., K=2 in FIG. 3).

FIG. 3 shows, in detail, how the node embedding predictor 322 operates to compute, score, and predict the embeddings. As mentioned above, aspects of the node embedding predictor 322 are taken from GCN models and RNN models, which can be observed in the exemplary structure and operation indicated in FIG. 3. For example, the node embedding predictor 322 combines the local view (message passing, neighborhoods Nb) with the global view (graph-specific parameters G) and the temporal view (recurrent model).

The node embedding predictor 322 has an embedding space that can be conceptualized as graph with layers increasing in the vertical direction and time-steps increasing in the horizontal direction. The node embedding predictor 322 walks through layers and time-steps as it learns, scores, and predicts the embeddings

$${h}_{n , t}^{( k )}$$

at each node v of the embedding graph.

A notable aspect of the architecture for the node embedding predictor 322 is that, for each embedding in each layer and each time-step, the embeddings from the previous layer as well as the previous time-step are integrated (apart from embedding

$${h}_{t - N}^{0}$$

at the base layer and earliest time-step). Alternatively, this can be described as, when computing a embedding for node v in the convolutional graph network, each layer in convolutional graph network represents looking at one hop in the neighborhood of the node v.

To illustrate this feature, take for example the computation of the embedding

$${h}_{t}^{2} ,$$

which is the embedding on the second layer at time-step t. The node embedding predictor 322 generates the embedding

$${h}_{t}^{2}$$

using as inputs: (1) the next-lower layer embedding

$${h}_{t}^{1}$$

from the same time-step; (2) the same layer embedding

$${h}_{t - 1}^{2}$$

from the from the next-previous time-step; and (3) the graph-specific parameters Gₜ. for the same time-step. The process can be extended for an arbitrary number of layers and time-steps.

Table 3 illustrates exemplary pseudo-code for computing embeddings.

TABLE 3
Embedding Computation:

```
Input:
    // param h_tm_1: tensor: embedding for each node from prev. timestep, current
    layer
    // param h_t_km: tensor: embedding for each node from current timestep, prev.
    layer
    // param neighborhood: dictionary, as extracted in Table 2. The neighborhood of
    each node at timestep t
    // param G_t: The Graph-specific parameters, as extracted in Table 1.
function update_embedding(h_t_1, h_tminus_2, G_t, neighborhood[t]):
  // Compute the update of the embedding over time, and related information, all in dict
  time_updates:
  time_updates =
  embedding_model.sequence_model.compute_time_update(h_tminus_2)
  // Update the embedding for this layer, taking into account the neighborhood at
  timestep t:
  layer_updates = embedding_model.compute_layer_update (time_updates,
  h_tminus_2, neighborhood[t], h_t_1, G_t) // See below for a definition of this
  function
  // Combine the time_updates and the layer_updates
    h_t_k = embedding_model.combine(time_updates, layer_updates)
    //return: embedding for each node: current timestep, current layer
    return embedding h_t_k
function embedding_model. compute_layer_update (time_updates, h_tminus_2,
neighborhood[t], h_t_1, G_t):
  hhat t k time = embedding_model.sequence_model.do_time_update(time_updates,
h_tminus_2)
  // Use a graph convolutional network to update the embedding for the next layer
based on the neighborhood (if update at layer 1, also look at 1-hop neighborhood):
  hhat_t_k_neighborhood = embedding_model.GCN.propagate(neighborhood[t],
h t_1)
  // Aggregate all the information that has been computed:
  aggregated_information = embedding_model.aggregate(G_t, hhat_t_k_time,
hhat_t_k_neighborhood)
  // Forward step for a parametrized model, e.g. MLP to get the combined update for
this layer
  layer_updates = embedding_model.model.forward(aggregated_information)
  return layer_updates
```

This integration is executed essentially the same done in every layer and for every time-step except for at base layer, i.e., for the base embeddings

$${h}_{t - N : t}^{0} .$$

The base embeddings

$${h}_{t - N : t}^{0} .$$

may be learned using an existing embedding method, which embeds the node id of all nodes to a vector representation, and, in another embodiment, if existing, node attributes. —In a simple approach, the base embeddings may be computed by doing a one hot encoding of the node id. Another approach to compute the base embeddings is to use pytorch.embedding(node_id), to create a vector embedding using the known PyTorch machine learning framework based on the Torch library.

To compute these embeddings, for each layer k and time-step t, our predictor applies a transformation similar to that of a GCN model layer, but also different in that it also uses information computed at the previous time-step at the very same layer.

By integrating, in every layer, the embeddings from previous time-steps, the node embedding predictor 322 is able to incorporate the knowledge about the evolution of the neighborhoods for each node, as compared to solely incorporating the knowledge about the node embedding itself at the highest layer.

Further, the node embedding predictor 322 integrates, for each time-step t in each layer of the convolutional graph, the respective time-dependent Graph information Gₜ. By integrating this information, the node embedding predictor 322 can better learn how the graph evolves over time by not only looking locally (e.g., at its neighborhood Nbₜ) but also at a global picture. Further, because the graph-specific information is a multi-variate time-series, the model can take into account time-series specific information, for example seasonality and drift of the graph.

Thus, a node embedding predictor may be optionally configured such that it is seasonally aware, i.e., as a seasonally-aware recurrent model. Not all node embeddings implemented according to aspects of the present disclosure are configured as such, however.

For a seasonality-aware recurrent model, the node embedding predictor is configured to integrate the notion of seasonality in a specific way. Specifically, the node embedding predictor is configured to extract the seasonality from the multi-variate time-series of graph-specific parameters G_{t-N:t}. The node embedding predictor will then train an individual model (each with a different parametrization) for the recurrent model for each step in the period, i.e. fₛ( ), where the subscript s marks the seasonality step. For example, if there is weekly seasonality, there will be one parametrization per day. This takes into account that the graphs evolve differently at different steps in the time-series, but due to seasonality it is known how they evolve at each element. This is optional; alternatively, one model can be trained, with no specific seasonality-aware parametrization.

The node embedding predictor may extract the seasonality from the multi-variate time-series of graph-specific parameters G_{t-N:t}. using methods known in the art, including using existing python packages to compute the seasonality parameter in each of the extracted time series. This leads to a set of ng values, where ng is the number of parameters in G. In one embodiment, the extracted seasonalities are aggregated, e.g. with a majority voting technique. If for example a weekly seasonality is found, this would mean the majority of the ng values says there is a seasonality value of 7.

Prior to deployment, the node embedding predictor and graph forecaster (explained in greater detail below) are trained.

According to an aspect of the present disclosure, the node embedding link predictor can be trained on link prediction, where the task is to predict links for future KG snapshots, e.g., (subject, relation, ?, t+i). The KG snapshots are split in training set, validation set, and test set, taking into account the order of time-steps, i.e. tₜₑₛₜ>t_{valid}>tₜᵣₐᵢₙ.

Table 4 (presented below) provides example pseudocode for implementing link prediction training.

TABLE 4
Link prediction training

```
Input: G_t-N:t, Neighborhood (Table 1,2); Ground_truth graphs (KG_t-N:t)
  for each epoch:
    for each timestep t in training set:
      // 1) Model Forward: compute H_t (the set of embeddings h_t for each node)
      based on past graphs parameters G_t-N:t, on neighborhood, and on pas
      embeddings;
      H_t = temporal_graphs.forward(H_tminus, G_t-N:t, neighborhood[t])
      // 2) Compute future Scores; decode H_t (set of embeddings h_t for each node) to
      get scores for t+1
      Scores_tplus = temporal_graphs.decode(H_t)
      // 3) Graph Forecaster
      Predicted_triples_number, predicted_triples =
      temporal_graphs.forecast_graph(scores_tplus, G_t-N:t )
      // 4) compute loss for the prediction for t+1:
      Actual_triples_number = temporal_graph.triples_number(G_t)
      loss = temporal_graphs.loss(scores_tplus, ground_truth_graph_tplus,
      predicted_triples_number, actual_triples_number)
        // 5) backprop
        loss.backward( )
        self.optimizer.step( )
```

In the following, exemplary details of the embedding generation, scoring, and prediction operations are provided by way of a preferred implementation of the node embedding predictor 322. Specifically, in the implementation, the GCN aspects of the model architecture are realized based on a graph isomorphism network (GIN), and the recurrent model aspects of the model architecture are realized based on a gated recurrent unit (GRU). However, it should be noted that other embodiments of the node embedding predictor could be based on a combination of any other GCN and RNN. See, e.g., K. Xu, W. Hu, J. Leskovec, and S. Jegelka, “How powerful are graph neural networks?” in International Conference on Learning Representations, 2019. (discussing GINs); and R. Dey and F. M. Salem, “Gate-variants of Gated Recurrent Unit (GRU) neural networks,” 2017 IEEE 60th International Midwest Symposium on Circuits and Systems (MWSCAS), Boston, MA, USA, 2017, pp. 1597-1600, 2017. (discussing GRUs) (the entire contents of each of which are hereby incorporated by reference herein.

According to this preferred embodiment, using the received inputs, the node embedding predictor 322 executes an update step to compute the node embedding h for layer k for time-step t according to the following equations 1a, 1b, 1c, and 1d:

$${z}_{v , t}^{( k )} = {f}_{s} ( {h}_{v , t - 1}^{( k )} ) \qquad ( 1 a )$$

$${r}_{v , t}^{( k )} = {g}_{s} ( {h}_{v , t - 1}^{( k )} ) \qquad ( 1 b )$$

$$( 1 c )$$

$${\tilde{h}}_{v , t}^{( k )} = {MLP}^{( k )} ( [ \begin{matrix}0 \\ 0 \\ {G}_{t}\end{matrix} ] + [ \begin{matrix}{h}_{v , t - 1}^{( k )} \\ 0 \\ 0\end{matrix} ] ⊙ [ \begin{matrix}{r}_{v , t}^{( k )} \\ 0 \\ 0\end{matrix} ] + ( 1 + {ϵ}^{( k )} ) [ \begin{matrix}{h}_{v , t}^{( k - 1 )} \\ 0 \\ 0\end{matrix} ] + {\sum }_{u ∈ N {b}_{v , t}} [ \begin{matrix}{h}_{u , t}^{( k - 1 )} \\ {h}_{u v} \\ 0\end{matrix} ] )$$

$${h}_{v , t}^{( k )} = ( 1 - {z}_{v , t}^{( k )} ) ⊙ {\tilde{h}}_{v , t}^{( k )} + {z}_{v , t}^{( k )} ⊙ {h}_{v , t - 1}^{( k )} \qquad ( 1 d )$$

with fₛ, gₛ being single-layer multi-layer perceptrons (MLPs). The s describes that a different model (i.e., different parametrization) is used for each seasonality. Further, k is the layer, t is the time-step, v is the node identification within the embedding space, hv is the embedding of node v at the time-step, and hᵤᵥ is the embedding of the relation that connects u and v at the time-step t. Here Nb_{v,t} is the neighborhood of node v at timestep t, and u is any node in the neighborhood Nb_{v,t} of node v at timestep t. Nb_{v,t} is the neighborhood as extracted by the neighborhood extractor. The MLP used can be any MLP. The operator ⊙ Is the Hadamard product. Further, ϵ is a learnable parameter, Gₜ is the vector entry at time-step t in the multi-variate time-series as extracted by the graph time-series Extractor. In the notation, 0 And 1 are all-zeros and all-ones vectors of the embedding dimension or dimension of Gₜ.

As the term is used herein, a single-layer MLP is a neural network architecture that consists of only one hidden layer (the “single-layer”) between the input and output layers. In this architecture, each node in the input layer is connected to every node in the hidden layer, and each node in the hidden layer is connected to every node in the output layer. The term “perceptron” refers to the individual nodes in the hidden and output layers, which use a weighted sum of the inputs followed by a nonlinear activation function to produce an output.

By applying a scoring function on top of the computed embeddings, the embeddings can be used for future link prediction:

oₜ₊₁=p(hₜ) (2)

Where p( ) is a scoring function. A scoring function is used to predict the likelihood of a link between two entities in the graph. The basic idea behind scoring functions is to assign a score to each possible link between a pair of entities. The scoring function takes as input a pair of entities (embeddings) and a set of candidate relationships (embeddings) that could potentially connect them. It then computes a score for each candidate relationship. In the present scenario, the score represents the likelihood that these entities will be connected in the subsequent timestep, t+1. In other words, the scoring function computes scores for given embeddings (subject, relation and object)—the triple with the highest computed score is the triple considered most likely. In one embodiment, p( ) is implemented using the DistMult scoring function. See, e.g., Bishan Yang et. al., “Embedding entities and relations for learning and inference in knowledge bases,” In Proceedings of ICLR (2015) (discussing DistMult) (the entire contents of which are hereby incorporated by reference herein). As a person of ordinary skill in the art would recognize, however, many alternative scoring functions may be used.

When multiple future time-steps are to be computed, the model can be repeated multiple times, using a recursive strategy.

The model also computes relation embeddings hᵤᵥ by using a scoring function p( ). This may be the same scoring function as used above for future link predictions.

FIG. 4 illustrates an embodiment of graph forecaster 400.

The graph forecaster 400 generates and outputs the predicted TKG forecast for the TKG forecasting system (e.g., the TKG forecasting system 100).

The graph forecaster 400 receives, as inputs 410 one or more of: (1) the predicted set of node embeddings

$${H}_{t + i} = \{ {h}_{N , t + i}^{( K )} , … , {h}_{N , t + i}^{( K )} \} ,$$

with N being the number of nodes for each future time-step(s) of interest t+i, and K indicating the highest layer of the embedding space; (2) the time-dependent graph information G_{t-N:t} for the full history of past time-steps. The inputs may be received from a node embedding predictor (e.g., the node embedding predictor 322); and the predicted set of scores oₜ₊₁.

Based on the received inputs, graph forecaster 400 generates and outputs the predicted TKG forecast 420. The predicted TKG forecast may be a single KG snapshot at the future time-step of interest or a sequence of KG snapshots predicted for each of the future time-steps of interest. In either case, the output may be structured as a set of triples (subjection, relation, object) for each future time-step of interest, or a set of quadruples (subject, relation, object, time). The sequence of KG snapshots may be predicted iteratively, e.g., by predicting embeddings, scores, the future graph for one future time-step, feeding back this information into the model, and then predicting another future time-step based on the feedback.

According to an aspect of the present disclosure, the graph forecaster 400 may be configured to apply the following method for each future time-step of interest:
A) Based on G_{t-N:t}, predict the values of Gₜ₊ᵢ using a multi-variate time-series forecasting model for the indicated future time-step.
   This includes the number of nodes (entities) numₑ as well as the number of triples numₜ at t+i. This means that the prediction for Gₜ₊ᵢ include the predicted number of nodes and number of triples in the KG.
B) Based on the predicted embeddings Hₜ₊ᵢ for the indicated future time-step and the scoring function p( ):
   a. Predict the numₑ nodes based on the predicted scores
   b. For these numₑ nodes: predict the numₜ most likely triples

Step A and Step B performed by the graph forecaster 400 are graphically illustrated as 430 and 440, respectively, in FIG. 4. The scoring function used in Step B may be the same scoring function that was used in the node embedding predictor.

In one embodiment, the Graph Forecaster uses a multi-variate autoregressive integrated moving average (ARIMA) model to predict the future values of the graph-specific parameters at the indicated future time-step Gₜ₊ᵢ. See, e.g., Box and Jenkins, “Time-Series Analysis, Forecasting and Control,” Holden-Day, San Francisco (1970) (the entire contents of which are hereby incorporated by reference herein).

The graph forecaster 400 outputs the predicted triples for the indicated future time-step as the forecasted KG snapshot. The forecaster 400 may also output predicted tipples for a plurality of indicated future time-steps as a collection of KG snapshots, each associated with a time-step, and collectively representing a sequence of TKGs.

The methods and systems provided according to aspects of the present disclosure can be practically integrated into prevention tool for predicting future scenarios, such as the development of crime cases in the public safety domain and the relation between these crime cases. In particular, the TGK forecasting system can be integrated into an automated computer tool enabling that tool to process a complex time-dependent dataset describing a system or process in a target domain, and make accurate predictions for how that system or process will exist at an indicated future time (or time sequence). The predicted state of the domain can be adapted to a practical application by being used for making complicated decisions on systems and processes that were here-to-fore impracticable to predict by humans alone, or even by the state of the art ML systems. At present, the inventors know of no systems that can efficiently (from a computational resource standpoint) and timely (from a computer processing time standpoint) process sufficient data (from a type and volume perspective) in such a way that embodiments of the present disclosure do, while also being able to accurately identify patterns in the dataset and accurately make the predictions necessary to enable a practical use of the predictions made.

### Use Cases

### Use Case 0—Biomedical AI, Patient Condition Prediction

Use Case: While observing the vital parameter of a patient e.g. in a hospital, it is beneficial if the doctors know how the condition of a patient will change in the future, e.g. to optimize the condition of the patient. In this context, the invention analyzes the current state of the patient and predicts the future development of the respective vital parameter, e.g., of the health condition/status. The time might be crucial in respect of the dose where the effect can exposure unwanted side-effects. The doctors can react to or prevent the predicted condition e.g., by adjusting the medical devices (e.g. ventilator or the amount of morphine). Alternatively, these devices can be directly adjusted without the human in the loop.

Data Sources: Available sensor networks in the hospital (e.g., body temperature, blood pressure); information about medicine; input from medical reports and patient reports;

Implemented Solution: The Patients condition is represented as a TKG, with the different connected components of the body, and to the surroundings of the patient, as well as the medicine received and potential interactions/reactions/side-effects between types of medicine. The system/method implemented according to aspects of the present disclosure may predict through TKG forecasting how the TKGs change overtime. This includes the expected development of the patients health condition for certain aspects. In particular, the occurrence or disappearance of certain properties or events (nodes) and changing relationships (edges) in the (near) future. More concretely, for example, the occurrence of a link between a patient condition, and a node representing a critical status could be predicted, or between medicines and unwanted side-effects.

Output: A KG or a set of KGs (e.g., a sequence of TKGs), describing the future development (e.g., which entities occur, re-occur, or vanish) and how the relationship between the entities changes.

Technicity: The Input to the system is based on sensor measurements to measure the physical state of the patient, for example temperature sensors and blood pressure sensors.

### Use Case 1—Public Safety Domain: Crime Investigation—Prevention

Use Case: For crime prevention it is essential to understand the development of high-risk areas and potential escalation points in a city or area, ideally before the crimes or accidents happen. This enables timely counteractions, i.e. the presence of more police forces or social workers, as well as the adjustment of those locations (i.e. street lights should always be turned on in corners that are considered high risk, and public places that are considered dangerous can be equipped with surveillance cameras). Integrating an embodiment of the TKG forecasting system, implemented according to an aspect of the present disclosure, in a forensic tool for crime prevention, allows for the continuous evaluation of a situation and for predicting high-risk locations. This includes the consideration of temporal events such as sport event and the related movements of people but also the nature of locations, e.g., parking lots or petrol stations. The temporal capability is of particular interest for dynamically changing situations that might arise spontaneously, e.g., predicting future risk scores for streets with upcoming traffic jams, for different road conditions due to storms, areas with demonstrations and other events. The output of a system according to embodiments of the present disclosure can be used to control other technical devices, e.g., surveillance applications or alarms.

Data Sources: Available sensor networks (e.g., camera, weather station, and presence sensors), (Smart) forensic tools, the database of the police force (e.g., past crime case records), sociodemographic information (e.g., characteristics of the social life in the district of interest), cameras, etc. This large, complex and time-dependent data source makes it impractical for humans or existing ML models to accurately and/or efficiently detect patterns and make predictions. However, embodiments of the present disclosure are able to fully integrate this data (as assembled in an sequence of KGs) and make accurate prediction relevant to the domain problem.

Implemented Solution: The system/method implemented according to aspects of the present disclosure may predict through TKG forecasting how the TKGs change overtime. This includes the expected development of (crime) hotspots. In particular, the occurrence or disappearance of certain properties or events (nodes) and changing relationships (edges) in the (near) future. More concretely, a change in the number of nodes may indicate a change in the number of crimes happening at each day, and may granularly show, e.g., that most crimes happening on Fridays of each week.

Output: A KG or a set of KGs (e.g., a sequence of TKGs), describing the future development (e.g., which entities occur, re-occur, or vanish) and how the relationship between the entities changes.

Technicity: The output of the system/method implemented according to aspects of the present disclosure can directly be used in evidence and prevention tools at crime places such as cameras, drones, light systems. In particular, the output of the system/method can control on which locations these prevention tools should be focused on (in comparison to just turning the lights in every street and every corner of the city on all night.). In addition, through a smart traffic system, the route or capacities (number of available lanes) can be adapted to control the traffic flow (e.g., to avoid that many cars pass a temporal dangerous place or area).

### Use Case 2—Smart City Domain: Predictive Maintenance Based on Camera Inputs

Use Case: In a smart city, buildings like bridges and towers but also urban vehicles like buses and trams need (regular) maintenance. Early detection of issues save costs and avoid accidents. A city sensor network, consisting of, e.g., optical, sound, and inertial sensors including cameras capture the situation and states of the various entities (e.g., a bridge). Further, consideration temporal events such as the traffic flow and the varying load enables an accurate assessment of the situation, i.e., how, e.g., a bridge is used and how this effects the state of the bridge.

Data Source: Available sensor networks (e.g., camera, weather station, and presence sensors), public and governmental databases (e.g., past case records), sociodemographic information (e.g., characteristics of the social life in the district of interest), cameras, etc. This large, complex and time-dependent data source makes it impractical for humans or existing ML models to efficiently and/or accurately detect patterns and make predictions. However, embodiments of the present disclosure are able to fully integrate this data (as assembled in an sequence of KG snapshots) and make accurate prediction relevant to the domain problem.

Implemented Solution: The system/method implemented according to aspects of the present disclosure may predict through TKG forecasting how the KG changes overtime. This includes the expected development of maintenance states. In particular, the occurrence or disappearance of certain properties or events (nodes) and changing relationships (edges) in the (near) future allow to capture multi-variate anomalies.

Output: A KG or a set of KGs, describing the future development, i.e., which entities occur, re-occur, or vanish and how the relationship between the entities changes. For any detected anomaly, the contribution of different signals (e.g., nodes occur or vanish) can be helpful in explaining the anomaly and analyzing the root cause.

Technicity: Input to the system/method implemented according to aspects of the present disclosure is sensor data that describes the state of the city, e.g., camera images containing information on the state of the bridge (e.g., cracks). Further, input data can be the camera images that show cars number plates, which are then mapped to drivers. The system/method according to embodiments disclosed herein can predict how the city will develop, how the different items develop, and how the traffic in the city will develop.

Use Case 3—Smart City Domain: Predictive Maintenance with Technical Output

Use Case: In a smart city, buildings like bridges and towers but also urban vehicles like buses and trams need (regular) maintenance. Early detection of issues save costs and avoid accidents. A city sensor network, consisting of, e.g., optical, sound, and inertial sensors including cameras capture the situation and states of the various entities (e.g., a bridge). Further, consideration temporal events such as the traffic flow and the varying load enables an accurate assessment of the situation, i.e., how, e.g., a bridge is used and how this effects the state of the bridge.

Data Source: Available sensor networks (e.g., camera, weather station, and presence sensors), public and governmental databases (e.g., past case records), sociodemographic information (e.g., characteristics of the social life in the district of interest), cameras, etc. This large, complex and time-dependent data source makes it impractical for humans or existing ML models to accurately detect patterns and make predictions. However, embodiments of the present disclosure are able to fully integrate this data (as assembled in an sequence of KGs) and make accurate prediction relevant to the domain problem.

Implemented Solution: The system/method implemented according to aspects of the present disclosure may predict through TKG forecasting how the KG changes overtime. This includes the expected development of maintenance states. In particular, the occurrence or disappearance of certain properties or events (nodes) and changing relationships (edges) in the (near) future allow to capture multi-variate anomalies.

Output: A KG or a set of KG snapshots, describing the future development, i.e., which entities occur, re-occur, or vanish and how the relationship between the entities changes. For any detected anomaly, the contribution of different signals (e.g., nodes occur or vanish) can be helpful in explaining the anomaly and analyzing the root cause.

Technicity: The output of the system/method implemented according to aspects of the present disclosure can directly be used to reroute traffic or reduce useable lanes to reduce the load on a bridge, lock/block elevators in a building or adapt the permitted weight, lock/block trams/buses automatically from usage to avoid accidents, evacuate a building (enable alarm, e.g. after an earthquake).

### Use Case 4—Smart City Domain: Predictive Maintenance: Train Track Maintenance and Routing

Use Case: In a public transportation, for trains, the tracks and trains need regular maintenance. Tracks in different states can cause problems and early attrition of trains and tracks, i.e. tracks in worse states will lead to higher attrition. Early detection of issues save costs and avoid accidents. A train track sensor network, consisting of, e.g., optical, sound, and inertial sensors including cameras captures the situation and states of the various entities (e.g., tracks in different locations, different types of trains). Further, consideration of temporal events such as the train schedule and the varying load, as well as weather conditions enables an accurate assessment of the situation, i.e., how, e.g., a train track is used and how this effects the state of the train tracks and trains.

Data Source: Available sensor networks (e.g., camera, weather station, and presence sensors), public transport databases (e.g., train schedules and train types), cameras, etc. This large, complex and time-dependent data source makes it impractical for humans or existing ML models to accurately and/or efficiently detect patterns and make predictions. However, embodiments of the present disclosure are able to fully integrate this data (as assembled in an sequence of KGs) and make accurate prediction relevant to the domain problem.

Implemented Solution: The system/method according to implemented according to aspects of the present disclosure may predict through TKG forecasting how the potential anomaly states of tracks and trains represented in the KG changes overtime. In particular, the occurrence or disappearance of certain properties or events (nodes) and changing relationships (edges) in the (near) future allow to capture multi-variate anomalies.

Output: A KG or a set KGs, describing the future development, i.e., which entities occur, re-occur, or vanish and how the relationship between the entities changes. For any detected anomaly, the contribution of different signals (e.g., nodes occur or vanish) can be helpful in explaining the anomaly and analyzing the root cause.

Technicity: The output of the system/method implemented according to aspects of the present disclosure can display the anomaly status and can directly be used to reroute trains to reduce the load on certain tracks, and to balance which trains are driving on which tracks or adapt the permitted weight. Lock/block trains automatically from usage to avoid accidents and early detect and schedule the replacement of certain vulnerable tracks.

### Use Case 5—Smart City Domain: Predictive Maintenance: Anomaly Prediction in Production Lines

Use Case: In a factory, products might turn out to be faulty in the end, based on the production lines they've been fabricated. Early detection of issues in production save costs and avoid waste. A sensor system in a factory, consisting of e.g. optical sensors and inputs from intermediary checks including cameras, captures the situation and states of the various entities (e.g., products, parts of the production line). Further, considering the movement of the products through the production lines over time, and the varying load at different steps in time enables accurate assessment of the situation, i.e. how, e.g. certain production machines are used and how this effects the state of the final product.

Data Source: Available sensor networks (e.g., camera, and presence sensors), factory databases (e.g., past records), product information (e.g., characteristics of products and materials), cameras, etc. This large, complex and time-dependent data source makes it impractical for humans or existing ML models to accurately and/or efficiently detect patterns and make predictions. However, embodiments of the present disclosure are able to fully integrate this data (as assembled in an sequence of KGs) and make accurate prediction relevant to the domain problem.

Implemented Solution: The system/method implemented according to aspects of the present disclosure may predict through TKG forecasting how the product state, represented in the KG, changes overtime. In particular, the occurrence or disappearance of certain properties or events (nodes) and changing relationships (edges) in the (near) future allow to capture multi-variate anomalies.

Output: A KG or a set of KG snapshots, describing the future states, i.e., which entities occur, re-occur, or vanish and how the relationship between the entities changes. For any detected anomaly, the contribution of different signals (e.g., nodes occur or vanish) can be helpful in explaining the anomaly and analyzing the root cause, for instance, the path in the production lines.

Technicity: The output of the system/method implemented according to aspects of the present disclosure can directly be used to reroute products in the production line or reschedule production to balance load, if anomalies are predicted, lock/block production machines automatically from the production to avoid accidents or fabrication errors, and enable alarms.

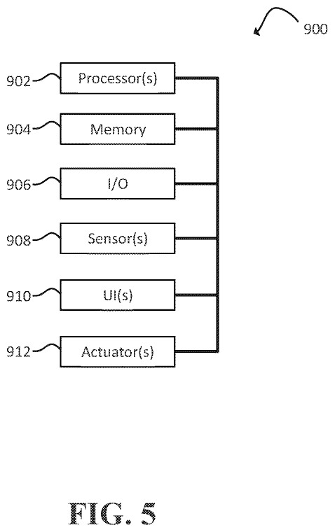

Referring to FIG. 5, a processing system 900 can include one or more processors 902, memory 904, one or more input/output devices 906, one or more sensors 908, one or more user interfaces 910, and one or more actuators 912. Processing system 900 can be representative of each computing system disclosed herein.

Processors 902 can include one or more distinct processors, each having one or more cores. Each of the distinct processors can have the same or different structure. Processors 902 can include one or more central processing units (CPUs), one or more graphics processing units (GPUs), circuitry (e.g., application specific integrated circuits (ASICs)), digital signal processors (DSPs), and the like. Processors 902 can be mounted to a common substrate or to multiple different substrates.

Processors 902 are configured to perform a certain function, method, or operation (e.g., are configured to provide for performance of a function, method, or operation) at least when one of the one or more of the distinct processors is capable of performing operations embodying the function, method, or operation. Processors 902 can perform operations embodying the function, method, or operation by, for example, executing code (e.g., interpreting scripts) stored on memory 904 and/or trafficking data through one or more ASICs. Processors 902, and thus processing system 900, can be configured to perform, automatically, any and all functions, methods, and operations disclosed herein. Therefore, processing system 900 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 900 can be configured to perform task “X”. Processing system 900 is configured to perform a function, method, or operation at least when processors 902 are configured to do the same.

Memory 904 can include volatile memory, non-volatile memory, and any other medium capable of storing data. Each of the volatile memory, non-volatile memory, and any other type of memory can include multiple different memory devices, located at multiple distinct locations and each having a different structure. Memory 904 can include remotely hosted (e.g., cloud) storage.

Examples of memory 904 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 904.

Input-output devices 906 can include any component for trafficking data such as ports, antennas (i.e., transceivers), printed conductive paths, and the like. Input-output devices 906 can enable wired communication via USB®, DisplayPort®, HDMI®, Ethernet, and the like. Input-output devices 906 can enable electronic, optical, magnetic, and holographic, communication with suitable memory 906. Input-output devices 906 can enable wireless communication via WiFi®, Bluetooth®, cellular (e.g., LTE®, CDMA®, GSM®, WiMax®, NFC®), GPS, and the like. Input-output devices 906 can include wired and/or wireless communication pathways.

Sensors 908 can capture physical measurements of environment and report the same to processors 902. User interface 910 can include displays, physical buttons, speakers, microphones, keyboards, and the like. Actuators 912 can enable processors 902 to control mechanical forces.

Processing system 900 can be distributed. For example, some components of processing system 900 can reside in a remote hosted network service (e.g., a cloud computing environment) while other components of processing system 900 can reside in a local computing system. Processing system 900 can have a modular design where certain modules include a plurality of the features/functions shown in FIG. 9. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer-implemented method for generating node embeddings for generating a forecasted temporal knowledge graph from a sequence of temporal knowledge graphs, the sequence comprising a plurality of time-steps, the method comprising:
predicting the node embeddings, using a machine learning model, which executes a multi-resolution temporal reasoning scheme that, in each update-layer of a graph convolutional network, integrates:
an evolvement of nodes and relations in the sequence of temporal knowledge graphs over time; and
values of a multi-variate time series of graph-specific parameters extracted from the sequence of temporal knowledge graphs.

2: The method of claim 1,
wherein the predicting the node embeddings, using the machine learning model, comprises:
computing scores, based on the predicted node embeddings, for a plurality of triples corresponding to a future time-step, and
wherein the method further comprises predicting the forecasted temporal knowledge graph based on the predicted node embeddings by:
forecasting graph-specific parameters based on the values of the multi-variate time series of graph-specific parameters; and
predicting a set of forecasted triples as the forecasted temporal knowledge graph based on the computed scores and the forecasted graph-specific parameters.

3: The method of claim 1, wherein the predicting the node embeddings, using the machine learning model, further comprises:
integrating, in each update-layer of the graph convolutional network, seasonality information; and
training a recurrent model component of the machine learning model using the seasonality information.

4: The method of claim 1, the method further comprising:
extracting, based on the sequence of the temporal knowledge graphs, the multi-variate time series of graph-specific parameters, each entry comprising a time-series of values of one of the graph-specific parameters characterizing the temporal knowledge graphs at the time-steps; and
extracting, based on the sequence of the temporal knowledge graphs, a neighborhood evolution identifying neighbors of each node in the temporal knowledge graphs at the respective time-steps,
wherein the evolvement of the nodes comprises the extracted neighborhood evolution.

5: The method of claim 1,
wherein the sequence of temporal knowledge graphs comprises a plurality of knowledge graph snapshots, each knowledge graph snapshot corresponding to a respective time-step of the time-steps in the sequence, and
wherein extracting the multi-variate time series of graph-specific parameters comprises, iteratively, for each of the time-steps:
extracting a respective value for each parameter of the graph-specific parameters of the knowledge graph snapshot corresponding to the respective time-step; and
adding the respective value for each parameter of the graph-specific parameters to the time-series of values of the respective one of the graph-specific parameters.

6: The method of claim 1,
wherein the sequence of temporal knowledge graphs comprises a plurality of knowledge graph snapshots, each knowledge graph snapshot being correlated with a respective time-step of the time-steps in the sequence, and
wherein generating the neighborhood time sequence comprises, iteratively, for each of the time-steps:
for each node of the knowledge graph snapshot corresponding to the respective time-step:
identifying all of the neighbors of the respective node; and
adding to a respective node entry in the neighborhood time sequence, the identified neighbors of the respective node.

7: The method of claim 1,
wherein the machine learning model comprises a multi-resolution temporal graph network (MR-TGN) model, which comprises:
a graph convolutional neural network model component; and
a recurrent neural network model component, and
wherein the MR-TGN model is configured to execute a message passing operation to update embeddings at each node of the graph convolutional network, the message passing operation comprising passing both the evolvement of nodes and the values of the multi-variate time series of graph-specific parameters according to a respective one of the time steps corresponding to the node.

8: The method of claim 1, wherein the predicting the node embeddings, using the machine learning model, further comprises:
computing node embeddings
$${h}_{v , t}^{( k )}$$
of the graph convolutional network using equations:
$${z}_{v , t}^{( k )} = {f}_{s} ( {h}_{v , t - 1}^{( k )} )$$
$${r}_{v , t}^{( k )} = {g}_{s} ( {h}_{v , t - 1}^{( k )} )$$
$${\tilde{h}}_{v , t}^{( k )} = {MLP}^{( k )} ( [ \begin{matrix}0 \\ 0 \\ {G}_{t}\end{matrix} ] + [ \begin{matrix}{h}_{v , t - 1}^{( k )} \\ 0 \\ 0\end{matrix} ] ⊙ [ \begin{matrix}{r}_{v , t}^{( k )} \\ 0 \\ 0\end{matrix} ] + ( 1 + {ε}^{( k )} ) [ \begin{matrix}{h}_{v , t}^{( k - 1 )} \\ 0 \\ 0\end{matrix} ] + {\sum }_{u ∈ N {b}_{v , t}} [ \begin{matrix}{h}_{u , t}^{( k - 1 )} \\ {h}_{u v} \\ 0\end{matrix} ] )$$
$${h}_{v , t}^{( k )} = ( 1 - {z}_{v , t}^{( k )} ) ⊙ {\tilde{h}}_{v , t}^{( k )} + {z}_{v , t}^{( k )} ⊙ {h}_{v , t - 1}^{( k )} ,$$
wherein fₛ( ) and gₛ( ) are single-layer, multi-layer perceptrons (MLPs), s indicating that a different MLP model is used for each seasonality,
wherein k is the update-layer, and t is the time-step,
wherein v is a node identification within an embedding space of the graph convolutional network,
wherein
$${h}_{v , t}^{( k )}$$
is an embedding of the node v at the respective time-step t, and the respective layer k,
wherein hᵤᵥ is an embedding of a relation that connects u and v at a present time-step,
wherein Nb_{v,t} is a neighborhood of the node v at the time-step t from the evolvement of nodes,
wherein operator ⊙ is the Hadamard product,
wherein ϵ is a learnable parameter of the model,
wherein Gₜ is a vector entry at the time-step t in the multi-variate time series of graph-specific parameters, and
wherein, on the notation, 0 And 1 are all-zeros and all-ones vectors of the embedding dimension or dimension of Gₜ.

9: The method of claim 1,
wherein the predicting of the forecasted temporal knowledge graph based on the predicted node embeddings comprises:
executing a scoring function based on the predicted node embeddings corresponding to a last layer of the graph convolutional network and a time of interest to predict a plurality of future nodes; and
predicting a set of triples based on the predicted plurality of future nodes, and
wherein the forecasted temporal knowledge graph comprises the predicted set of triples for the time of interest.

10: The method of claim 1, wherein the predicting of the forecasted temporal knowledge graph based on the predicted node embeddings comprises:
predicting graph-specific parameter values for a future time of interest based on the a multi-variate time series of graph-specific parameters using a multi-variate time-series forecasting model; and
constraining the predicted plurality of future nodes based on the predicted graph-specific parameter values.

11: The method of claim 1, wherein the predicted graph-specific parameter values comprises at least one of a number of nodes in the future time of interest and/or a number of triples at a future time-step.

12: The method of claim 1,
wherein the machine learning model is trained to predicting the node embeddings for use in predicting maintenance tasks,
wherein the sequence of temporal knowledge graphs were generated based on a plurality of time dependent data sources comprising at least one of:
data from sensor networks, which comprise one or more of cameras, presence sensors, inertial sensors, or weather stations;
public databases, which comprise public transportation schedules or vehicle types; or
a factory database, which comprises at least one of past production records, maintenance records, production information, or equipment information, and
wherein the method further comprises predicting the forecasted temporal knowledge graph based on the predicted node embeddings, the forecasted temporal knowledge graph being configured to forecast at least one of how a product, vehicle, or piece of equipment state changes over time.

13: The method of claim 1, wherein the graph-specific parameters comprise at least one of: a number of nodes, a number of relations, a maximum node degree, a maximum degree centrality, or a density.

14: A system comprising one or more hardware processors which, alone or in combination, are configured to provide for execution of a method for generating node embeddings for generating a forecasted temporal knowledge graph from a sequence of temporal knowledge graphs, the sequence comprising a plurality of time-steps, the method comprising:
predicting the node embeddings, using a machine learning model, which executes a multi-resolution temporal reasoning scheme that, in each update-layer of a graph convolutional network, integrates:
an evolvement of nodes and relations in the sequence of temporal knowledge graphs over time; and
values of a multi-variate time series of graph-specific parameters extracted from the sequence of temporal knowledge graphs.

15: A tangible, non-transitory computer-readable medium having instructions thereon which, upon being executed by one or more hardware processors, alone or in combination, provide for execution of a method for generating node embeddings for generating a forecasted temporal knowledge graph from a sequence of temporal knowledge graphs, the sequence comprising a plurality of time-steps, the method comprising:
predicting the node embeddings, using a machine learning model, which executes a multi-resolution temporal reasoning scheme that, in each update-layer of a graph convolutional network, integrates:
an evolvement of nodes and relations in the sequence of temporal knowledge graphs over time; and
values of a multi-variate time series of graph-specific parameters extracted from the sequence of temporal knowledge graphs.
